(19) United States
(12) Patent Application Publication
(10) Pub. No.: US 2025/0232381 A1
(43) Pub. Date: Jul. 17, 2025

(54) SYSTEMS AND METHODS FOR DATA MAPPING BETWEEN UPSTREAM AND DOWNSTREAM INSURANCE SYSTEMS

(71) Applicant: Chubb INA Holdings, Inc., Philadelphia, PA (US)

(72) Inventors: Sunith Kumar Roy, Chester, NJ (US); Gaurang Desai, West Windsor, NJ (US)

(21) Appl. No.: 19/057,086

(22) Filed: Feb. 19, 2025

Related U.S. Application Data
(63) Continuation of application No. 17/667,001, filed on Feb. 8, 2022.

(51) Int. Cl. G06Q 40/08; G06F 16/14

(52) U.S. Cl. CPC G06Q 40/08; G06F 16/14

(57) ABSTRACT

A method for generating a product data structure specifying a mapping is described. The method includes receiving, by a data processing system, an input that specifies requirements for an insurance product, the requirements including (i) a first set of requirements defined by an upstream system and specifying underwriting workflow and operational workflow associated with the insurance product, and (ii) a second set of requirements defined by one or more downstream systems and specifying attributes of the insurance product that each of the downstream systems requires to create the insurance product. The method includes processing the input to generate meta-data that defines at least one of a risk structure or a coverage associated with the insurance product, generating a data structure specifying a mapping between the upstream system and each of the one or more downstream systems, and storing, in a hardware storage device, the data processing system.

This application is a continuation application of and claims priority to U.S. application Ser. No. 17/667,001, filed on Feb. 8, 2022, the entire contents of which are hereby incorporated by reference.

### BACKGROUND

Insurance companies use upstream systems and downstream systems to create and manage individual insurance policies for customers or policy holders through an issuance process. An example of an upstream system is a policy administration system that is used to execute insurance functions such as rating, quoting, binding, issuing, endorsements, and renewals. A policy administration system may record all policies that an insurance company has written. Downstream systems are dependent on data from the upstream systems. Downstream systems acquire data from upstream systems, provide additional processing and interpret upstream system data to provide additional business values. An example of a downstream system is a billing system that allows insurance companies to process and track all policy receivables and payables.

### SUMMARY

In general, one innovative aspect of the subject matter described in this specification can be embodied in methods for generating a product data structure specifying a mapping. The methods include the actions of receiving an input that specifies a plurality of requirements for an insurance product, in which the plurality of requirements include (i) a first set of requirements defined by an upstream system and specifying underwriting workflow and operational workflow associated with the insurance product, and (ii) a second set of requirements defined by one or more downstream systems and specifying attributes of the insurance product that each of the one or more downstream systems requires to create the insurance product; processing the input to generate meta-data that defines at least one of a risk structure or a coverage associated with the insurance product; based on the generated meta-data and the second set of requirements, generating a data mapping between the upstream system and each of the one or more downstream systems; and storing, in a hardware storage device, the data processing system.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The upstream system may be a policy admin system configured to perform a plurality of tasks related to insurance products. The plurality of tasks may include rating, quoting, binding, issuing, endorsements, and renewals of insurance policies. The policy admin system may be one of DuckCreek, Guidwire, Majesco, or other customized configuration-based policy admin system. The one or more downstream systems may include one or more of a financial system, a claim system, an operational and bureau reporting system, or a billing system. The underwriting workflow may include capturing policy data to underwrite a risk associated with the insurance product based on one or more underwriting guidelines. Capturing policy data may include capturing data related to account information, insured information, forms of the insurance product, risk characteristic, coverages, premium and surcharges information, and billing information. The operation workflow may include executing a policy of the insurance product during a life-cycle of the policy. The methods may further include, based on the first set of requirements, the second set of requirements and the data mapping, generating test data and test scenarios for testing the upstream system and the one or more downstream systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a system for providing data mappings between an upstream system and one or more downstream systems for generating a new insurance product.

FIG. 2 illustrates an example of data mappings between an upstream system and one or more downstream systems.

FIG. 3 is a flow diagram of an example process for providing data mappings between an upstream system and one or more downstream systems.

Like reference numbers and designations in the various drawings indicate like elements.

### DETAILED DESCRIPTION

Insurance companies use upstream systems and downstream systems to create and manage individual insurance policies for customers or policy holders through an issuance process. An example of an upstream system is a policy administration system that is used to execute insurance functions such as rating, quoting, binding, issuing, endorsements, and renewals. A policy administration system may record all policies that an insurance company has written. Downstream systems are dependent on data from the upstream systems. Downstream systems acquire data from upstream systems, provide additional processing (for example, perform rule-based calculations on it), and interpret upstream system data to provide additional business values. An example of a downstream system is a billing system that allows insurance companies to process and track all policy receivables and payables.

To construct/implement a new insurance product or to update an existing insurance product with new features, insurance companies typically perform the following process using upstream and downstream systems:
(1) Define an insurance risk associated with the insurance product and attributes of the risk;
(2) Define an insurance coverage of the new insurance product and attributes of the insurance coverage;
(3) Define a relationship between the risk and the coverage;
(4) Define forms, rules and a rating algorithm for a coverage of the new insurance product;
(5) Define underwriting questions to assess eligibility and price the risk;
(6) Define state and class eligibility; and
(7) Define how the risk and coverage will be reported to regulatory bodies, financial reports, claim processing unit and reinsurance partners.

In the above process, an insurance risk is defined as a threat or peril that the insurance company has agreed to insure against in the policy wordings. An insurance coverage refers to the amount of risk or liability that is covered for an individual or entity by way of insurance services. An attribute of the coverage is a property, characteristics, or value of the coverage. An attribute of the risk is a property, characteristics, or value of the risk. Forms are the contract document that make up the insurance product. Rules include rating rules and business rules. Rating rules require that insurers must submit the rate and the calculation to the state prior to launching the insurance product into market. Rating rules define the amount that an insurer will charge to cover the risk for an insured. Business rules refer to conditions that one must meet to be eligible for certain type of insurance. Business rules may also dictate the type of insurance product or a coverage one can buy.

Because the traditional process for constructing/implementing a new insurance product is sequential and merely leverages basic tools, it poses the following technical challenges that hamper the construction and implementation of new insurance products:
Isolated requirements collection causing product release delay: To create a new insurance product, each team in an insurance company needs to collect requirements independent of each other. This isolated requirements collection process leads to conflicting coverage specification. The requirement conflicts are often identified very late in the process of building new insurance products, thus delaying the release of the new insurance product to the market.
Lack of automation in development and testing cycle: Existing systems require each team to capture the requirements of a new insurance product and to manually provide the requirements to a development team to develop the functionality of the product and a testing team to develop test data and test scenarios to test the product. The lack of automation in development and testing cycle slows down the product release to the market.
Use of basic tools to capture requirements making it difficult to trace and update changes: Each team manages its requirements using basic tools. For example, Excel sheets or Word documents are used to document requirements of an upstream system, e.g., a policy admin system. Downstream system teams create Excel or Word documents that describe each downstream system individually. Basic tools such as Word documents and Excel sheets do not provide capability to trace the changes across multiple releases and multiple documents. Apart from this, basic tools do not provide capability to view the dependencies between various components across the insurance product or way of performing impact analysis of the product. Therefore, the use of basic tools make it difficult to trace and update changes and dependencies. This may cause inaccurate, out-of-date mappings between upstream and downstream systems. As another example, emails are used to communicate crucial decisions and the emails may not propagate to all stakeholders of an insurance company. Thus, team members may miss an email and failed to follow a direction given in the email.
Lack of a search facility for an existing mapping: Basic tools such as Word documents and Excel sheets do not provide capability to trace the changes to specific release or existing coverage, forms, rules, or rating specification. This limitation hinders reusability. For example, a product architect may create a new cyber product specification even though there may be a cyber product that has already been defined for another line of business. There can be as many as tens of thousands of different combinations of coverage and peril codes that one needs to review to derive a mapping between an upstream system and a downstream system for a new insurance product definition. However, existing tools do not allow users to search for existing mappings and reuse them.
Duplication of manual efforts for data mapping between an upstream system and one or more downstream systems: As requirements gathering is performed in an isolated manner and manually updated by each team using basic tools, each team may create a new mapping even though there may be an existing mapping that could have been utilized to reduce the development and testing efforts.

To address the above technical challenges of traditional insurance systems, this specification describes techniques for generating an insurance product by using a product designer system that automatically collects requirements from an upstream system and one or more downstream systems. The product designer system generates meta-data that defines a risk structure and a coverage associated with the insurance product. Based on the generated meta-data and the requirements, the product designer system automatically generates a data mapping between the upstream system and each of the one or more downstream systems. The product designer system as described herein allows for real-time updates of requirements and re-generation of mappings between the upstream and downstream systems. Further, the product designer system allows for efficient searching of existing mappings. Thus, systems that utilize the product designer system can reuse existing mappings, thereby reducing development and testing efforts and reducing computational resources (e.g., memory, processing power, etc.) that would otherwise be required by traditional systems to re-generate these mappings.

The techniques described herein would improve the process of generating a new insurance product and speed up the release of the product to the market. This is because the product design system would (i) allow for collaboration between multiple teams across insurance value chain, (ii) provide consistency in product definition across multiple systems, (iii) provide consistency in product implementation across various upstream systems (e.g., various policy admin systems), (iv) allow for reuse of existing coverage, risk definition for new products, (v) make it easy to search and retrieve existing coverage and requirements, and (vi) allow for generation of code/configuration for different systems based on the requirements captured at a centralized repository.

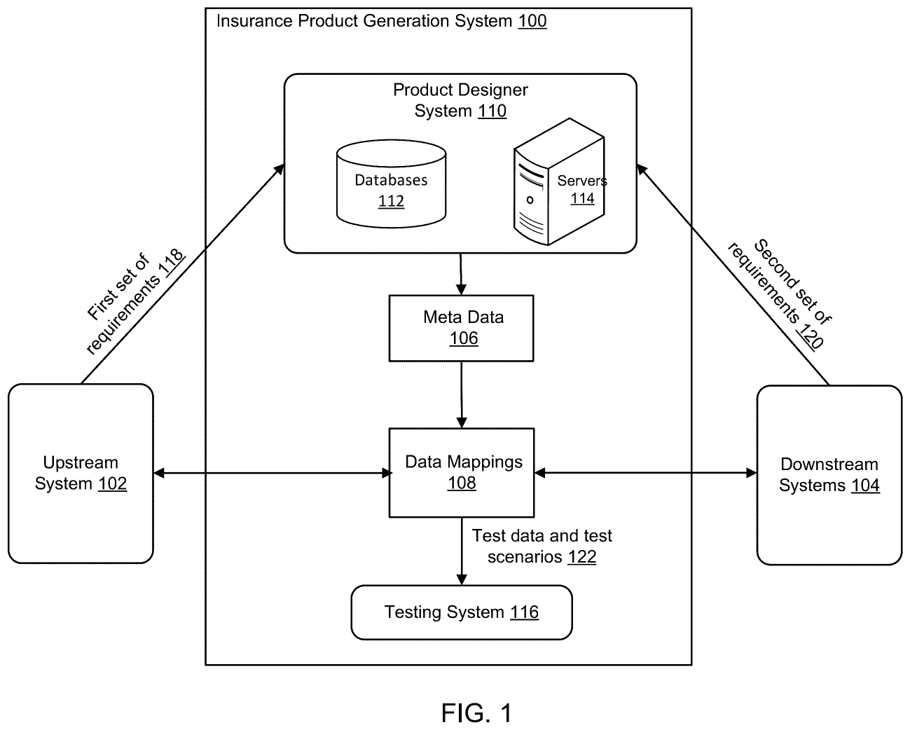

FIG. 1 illustrates an example of a system for generating a product data structure specifying a mapping. The mapping is used in the process of creating a new insurance product. In particular, as shown in FIG. 1, the insurance product generation system 100 is an example of a system implemented as computer programs on one or more computers in one or more locations, in which the systems, components, and techniques described below can be implemented.

The insurance product generation system 100 includes a product designer system 110 which is a data processing system and a testing system 112. The product designer system 110 may include a server system 114 and databases 112. The server system 114 may include one or more servers coupled to the Internet or other computer network. The server system 114 may be located at an organization (e.g., an insurance company) or distributed across the Internet or other computer network. The databases 112 is configured to store requirements for the new insurance products. In some implementations, the database system 112 resides at a local server system (e.g., a server system of an insurance company). In some other implementations, the database system 112 is a cloud-based database system.

To generate a new insurance product, the product design system 110 collects requirements for the insurance product from an upstream system 102 and one or more downstream systems 104. The upstream system 102 can be a policy admin system that is configured to perform a plurality of tasks related to insurance products. The policy admin system can be one of DuckCreek, Guidwire, Majesco, or other customized configuration-based policy admin system. The plurality of tasks may include, for example, rating, quoting, binding, issuing, endorsements, and renewals of insurance policies. The one or more downstream systems many include one or more of a financial system, a claim system, an operational and bureau reporting system, or a billing system.

In particular, the system 110 receives as input a first set of requirements 118 and a second set of requirements 120. The first set of requirements 118 is defined by the upstream system 102 and specifies underwriting workflow and operational workflow associated with the insurance product. The underwriting workflow may include capturing policy data to underwrite a risk associated with the insurance product based on one or more underwriting guidelines. Capturing policy data may include capturing data related to account information, insured information, forms of the insurance product, risk characteristic, coverages, premium and surcharges information, and billing information. The operation workflow may include executing a policy of the insurance product during a life-cycle of the policy.

The second set of requirements 120 is defined by the one or more downstream systems 104 and specifies attributes of the insurance product that each of the one or more downstream systems 104 requires to create the new insurance product.

After receiving the input, the product designer system 100 processes the input to generate meta-data 106 that defines a risk structure and/or a coverage associated with the insurance product. The risk structure specifies one or more risk objects that are protected by the insurance policy of the insurance product. For instance, a risk object may be a property, an item, or a responsibility that is protected by the insurance policy. For example, in case of an auto insurance policy, the risk object is a vehicle. As another example, in case of a home insurance policy, the risk objects are a dwelling, personal items, and liability.

In some implementations, the meta-data 106 may define an insurance coverage which is applicable for a particular class code (e.g., a particular class code that specifies a type of business in a particular state). For instance, the meta-date 106 may define a Directors & Officers (D&O) insurance coverage applicable only for class code 1001 in state of New York and/or class code 1003 in state of Pennsylvania. The meta-data can further define one or more of (i) a scope of forms of the new insurance product, (ii) one or more attachment rules which determine one or more specific forms that should be attached to the insurance policy (e.g., if an insurance limit is more than a threshold limit, then form X should be attached. If an insurance policy includes a certain amount of coverage, then form Y should be attached), (iii) state eligibility rules associated with the new insurance product, and (iv) class eligibility rules associated with the new insurance product. State eligibility rules specify one or more specific forms that should be attached to the new insurance product based on the state of the insured. Class eligibility rules specify a class code (i.e., a type of business) that drives the selection of forms to be attached to the new insurance product.

Based on the generated meta-data 106 and the second set of requirements 120, the product designer system 110 generates a data mapping 108 between the upstream system 102 and each of the one or more downstream systems 104. In this example, data mapping 108 is a data structure that specifies the mapping

In particular, to generate the data mapping 108, the product designer system 110 performs the following operations:
1. Collecting a first set of data elements located in the database 112 based on the first set of requirements 118 of the upstream system 102. For example, the system 110 collects data elements from the upstream system 102′s specification (e.g., a policy xml file) in the databases 112. The collected data elements may include a policy number retrieved from the path of root/policy/policyNumber in the policy xml file, and a D&O coverage limit retrieved from the path of root/policy/dno/limit in the policy xml file.
2. Collecting a second set of data elements located in the database 112. The second set of data elements is defined by the second set of requirements 120 of the downstream systems 104. For example, the system 110 collects data elements including policyNumber for policy number, Participant Direction Option (PDO) for D&O coverage, and limit for D&O limit.
3. For each of the downstream systems 104, creating an entry for a data mapping between the upstream system 102's requirements and the downstream system's requirements. The data mappings 108 can be generated in a form of a comma-separated values (CSV) file, a JavaScript Object Notation (JSON) file, or an Extensible Markup Language (XML) file.

After generating each of the data mappings 108, the system 110 may push the data mapping to an integration hub so that the integration hub can transform the data (e.g., the policy xml file) from the upstream system 102 into a data schema (e.g. a downstream xml schema) corresponding to each of the downstream systems 104.

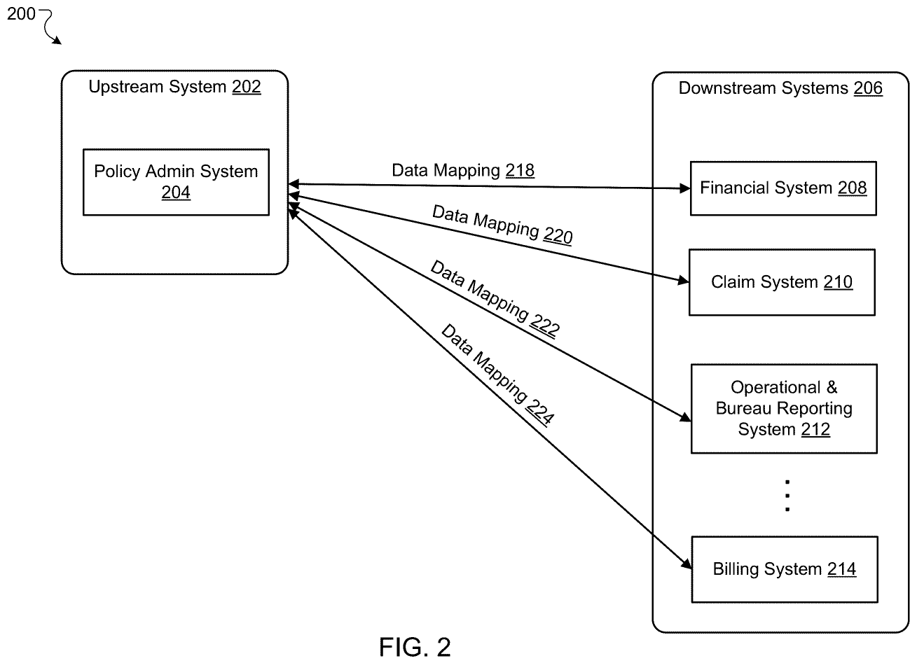

Examples of data mappings between the upstream system 102 and each of the one or more downstream systems 104 are described in more detail below with reference to FIG. 2.

In some implementations, the product designer system 110 is configured to provide a tool for users to search and review the development of requirements (e.g., requirements for coverages, forms, data fields, attributes and other rules) associated with the new insurance product. In some implementations, the product designer system 110 is configured to provide a graphical representation of a functional relationship between various components that build the new insurance product. In particular, the system 110 stores the relationship between components of a product so that if a user opens a particular component on a diagram, the system 110 can show other component(s) which may be parent to the component or children of the particular component. The user can select other component(s) to view quick summary or double click on the component to navigate and view its dependency on other component(s).

In some implementations, the product designer system 110 generates test data and test scenarios 122 based on the first set of requirements 118, the second set of requirements 120 and the data mapping 108.

Test data is the data that the testing system 116 should use to test the functionality of the new insurance product. As the system 110 gains the knowledge of data types, default values, min and max values of the requirements 118 and 120, the system 110 can generate random test data within specified ranges. For example, an insurance limit is a number and has a default value of 50K, 100K, or 150K. As another example, test data can be generated with one of a plurality of values such as 50K, 100K, and 150K.

Test scenario is the list of steps that a testing system 116 should execute to test the functionality of the new insurance product.

An example of the steps in a test scenario includes:
1. Opening an upstream portal (e.g., a DuckCreek portal)
2. Creating a quote with following details:
   a. Select a state (e.g., Nebraska),
   b. Select a line of business (e.g., commercial),
   c. Select an insurance coverage (e.g., D&O insurance coverage), and
   d. Select an insurance limit (e.g., 50K, 100K or 150K).
3. Validating the premium which is XXX amount.

The test data and test scenarios 122 are used to test the new insurance product once it is implemented on different systems. The test data and test script will help a quality testing system to quickly validate these systems against the requirements and specification of the new insurance product.

The product designer system 110 provides the test data and test scenarios 122 to the testing system 116 for testing the new insurance product.

FIG. 2 illustrates an example of data mappings between an upstream system and one or more downstream systems.

The upstream system 202 includes a policy admin system 204. The downstream systems 206 include one or more of a financial system 208, a claim system 210, an operational and bureau reporting system 212, a billing system 214, a registration system, a reinsurance system, a commercial and worker compensation billing system, an annual reporting tool, a claim data warehouse, or other types of downstream system. The policy admin system 204 captures data related to account information, insured information, forms of the insurance product, risk characteristics, coverages, sub-coverages, premium and surcharges information, agent commissions, and billing information. Each of the downstream systems 206 requires a subset of the data captured by the policy admin system 204. For example, the financial system 208 requires data related to premiums and taxes. The claim system 210 requires data related to the insured, risk characteristics, coverages, sub coverages, and forms. The operational and bureau reporting system 212 focuses on servicing and state reporting needs. For example, the operation and bureau reporting system 212 can generate a monthly and annual report that needs to be submitted to state agency such as the Department of Insurance (DOI). Based on the state reporting requirements, the number of insurances that have been issued can be determined. The billing system 214 requires data related to insureds, premiums, surcharges, and agent commissions. The product designer system 110 is configured to identify which downstream system requires which types of data from the upstream system 202 and then generate data mappings between the policy admin system 204 to the downstream systems 206. In this example, the product designer system 110 generates four data mappings: data mapping 218 between the system 204 and the financial system 208, data mapping 220 between the system 204 and the claim system 210, data mapping 222 between the system 204 and the operational and bureau reporting system 212, and data mapping 214 between the system 204 and the billing system 214.

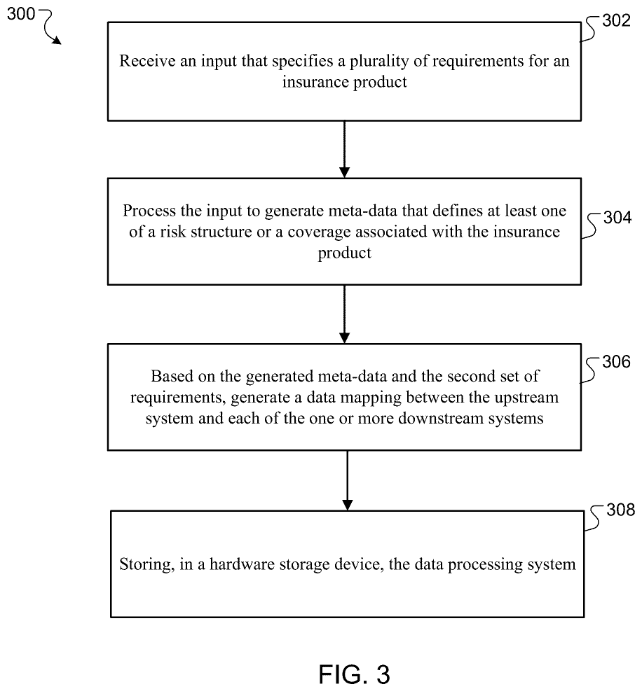

FIG. 3 is a flow diagram of an example process for providing data mappings between an upstream system and one or more downstream systems. For convenience, the process 300 will be described as being performed by a system of one or more computers located in one or more locations. For example, an insurance product generation system, e.g., the insurance product generation system 100 of FIG. 1, appropriately programmed in accordance with this specification, can perform the process 300.

The system receives, by a data processing system, an input that specifies a plurality of requirements for an insurance product (step 302). The plurality of requirements includes (i) a first set of requirements defined by an upstream system and specifying underwriting workflow and operational workflow associated with the insurance product, and (ii) a second set of requirements defined by one or more downstream systems and specifying attributes of the insurance product that each of the one or more downstream systems requires to create the insurance product.

The upstream system may be a policy admin system configured to perform a plurality of tasks related to insurance products. The plurality of tasks may include rating, quoting, binding, issuing, endorsements, and renewals of insurance policies. The policy admin system may be one of DuckCreek, Guidwire, Majesco, or other customized configuration-based policy admin system. The one or more downstream systems may include one or more of a financial system, a claim system, an operational and bureau reporting system, or a billing system.

The underwriting workflow may include capturing policy data to underwrite a risk associated with the insurance product based on one or more underwriting guidelines. Capturing policy data may include capturing data related to account information, insured information, forms of the insurance product, risk characteristic, coverages, premium and surcharges information, and billing information. The operation workflow may include executing a policy of the insurance product during a life-cycle of the policy.

The system processes, by a data processing system, the input to generate meta-data that defines a risk structure and a coverage associated with the insurance product (step 304). The risk structure specifies one or more risk objects that are protected by the insurance policy of the insurance product.

Based on the generated meta-data and the second set of requirements, the system generates, by the data processing system, a data mapping between the upstream system and each of the one or more downstream systems (step 306). The system stores, in a hardware storage device, the data processing system (step 308).

In some implementations, based on the first set of requirements, the second set of requirements and the data mapping, the system generates test data and test scenarios for testing the upstream system and the one or more downstream systems.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
receiving, by a data processing system that includes one or more computers, an input that specifies a plurality of requirements for a first product, wherein the plurality of requirements include (i) a first set of requirements defined for an upstream computer system that receives input for the product and performs one or more first operations on the input and specifying underwriting workflow and operational workflow associated with the product, and (ii) a second set of requirements defined for a downstream computer system that receives data generated by the upstream computer system and performs one or more second, different operations on the data and specifying attributes of the product that the downstream computer system requires to create the product;
in response to receiving the input that specifies the plurality of requirements for the product, generating, by the data processing system and using the input, meta-data that defines one or more values processed by the upstream computer system for the product;
using the generated meta-data and the second set of requirements, automatically generating, by the data processing system, a data structure specifying a data mapping between requirements from the first set of requirements defined for the upstream computer system to corresponding requirements from the second set of requirements defined for the downstream computer system;
in response to generating the data structure specifying the data mapping, generating, by the data processing system, one or more computer automated test scenarios and computer test data that includes one or more data types, one or more default values, one or more minimum values, and one or more maximum values,
the one or more computer automated test scenarios defining a plurality of computer operations at least some of which require the computer test data as input for validating an accuracy of the upstream computer system and the downstream computer system given the first set of requirements and the second set of requirements using the computer test data the first set of requirements, the second set of requirements and the data mapping;
generating, by the data processing system, test result data by executing, using at least a portion of the computer test data as input to the data processing system that includes the one or more computers, the one or more computer automated test scenarios for validating the accuracy of the upstream computer system and the downstream computer system given the first set of requirements and the second set of requirements using the first set of requirements, the second set of requirements and the data mapping, wherein the one or more computer automated test scenarios, the computer test data, and the test result data comprise different data;
validating the accuracy of the upstream computer system and the downstream computer system using the test result data;
in response to validating the accuracy of the upstream computer system and the downstream computer system, storing, by the data processing system and in one or more hardware storage devices, a) the data structure specifying the mapping between the first set of requirements defined for the upstream computer system and the second set of requirements defined for the downstream computer system and b) the test result data that indicates that the data structure is valid and the data processing system should not validate the accuracy of one or more requirements in the request given the test result data stored in the database;
receiving, by the data processing system, a request that identifies the product;
determining, by the data processing system and using second meta-data from the one or more hardware storage devices that is for a second, different product, whether the one or more hardware storage devices include a previously generated data structure that specifies a previously generated mapping for the upstream and downstream computer systems for the first product and whether the data processing system should validate an accuracy of one or more requirements in the request; and
in response to determining that the hardware storage device includes the previously generated data structure that specifies the previously generated mapping for the upstream and downstream computer systems for the first product and that the data processing system should not validate the accuracy of one or more requirements in the request for the second, different product given the test result data stored in the database:
determining, by the data processing system, to skip generation of another data structure specifying the mapping between the first set of requirements defined for the upstream computer system and the second set of requirements defined for the downstream computer system;
providing, by the data processing system, the previously generated data structure specifying the mapping between the first set of requirements defined for the upstream computer system and the second set of requirements defined for the downstream computer system; and
providing, by the data processing system, a message indicating that the test result data for the mapping was already generated.

2. The method of claim 1, wherein the upstream system is a policy admin system configured to perform the one or more first operations related to products.

3. The method of claim 2, wherein the downstream system includes one or more of a financial system, a claim system, an operational and bureau reporting system, or a billing system.

4. The method of claim 1, wherein the underwriting workflow includes capturing policy data to underwrite a risk associated with the product based on one or more underwriting guidelines.

5. The method of claim 4, wherein capturing policy data includes capturing data related to account information, forms of the product, risk characteristic, coverages, premium and surcharges information, and billing information.

6. The method of claim 1, wherein the operation workflow includes executing a policy of the product during a life-cycle of the policy.

7. A system comprising:
one or more processors; and
one or more non-transitory computer-readable storage media storing instructions that, when executed by the one or more processors, cause the one or more processors to perform operations for generating a product data structure specifying a mapping, the operations comprising:
receiving an input that specifies a plurality of requirements for a product, wherein the plurality of requirements include (i) a first set of requirements defined for an upstream system that receives input for the product and performs one or more first operations on the input and specifying underwriting workflow and operational workflow associated with the product, and (ii) a second set of requirements defined for a downstream system that receives data generated by the upstream system and performs one or more second, different operations on the data and specifying attributes of the product that the downstream system requires to create the product;
in response to receiving the input that specifies the plurality of requirements for the product, generating, using the input, meta-data that defines one or more values processed by the upstream system for the product;
using the generated meta-data and the second set of requirements, automatically generating a data structure specifying a mapping between requirements from the first set of requirements defined for the upstream system to corresponding requirements from the second set of requirements defined for the downstream system;
storing, by the system and in a hardware storage device, the data structure specifying the mapping between the first set of requirements defined for the upstream system and the second set of requirements defined for the downstream system;
generating, by the system, one or more computer automated test scenarios and computer test data, the automated test scenarios defining a plurality of operations at least some of which require the computer test data as input for validating an accuracy of the upstream system and the downstream system given the first set of requirements and the second set of requirements using the first set of requirements and the computer test data defining one or more data types, one or more default values, one or more minimum values, and one or more maximum values, the second set of requirements and the data mapping;
generating, by the system, test result data by executing, using at least a portion of the computer test data as input, at the one or more computer automated test scenarios for validating the accuracy of the upstream system and the downstream system given the first set of requirements and the second set of requirements using the first set of requirements, the second set of requirements and the data mapping;
storing, by the system and in a database, the test result data;
receiving, by the system, a request that identifies the product;
determining, by the system, whether the hardware storage device includes a previously generated data structure that specifies a previously generated mapping for the upstream and downstream systems for the product and whether the system should validate an accuracy of one or more requirements in the request; and
in response to determining that the hardware storage device includes the previously generated data structure that specifies the previously generated mapping for the upstream and downstream systems for the product and that the system should not validate the accuracy of one or more requirements in the request given the test result data stored in the database:
determining, by the system, to skip generation of another data structure specifying the mapping between the first set of requirements defined for the upstream system and the second set of requirements defined for the downstream system;
providing, by the system, the previously generated data structure specifying the mapping between the first set of requirements defined for the upstream system and the second set of requirements defined for the downstream system; and
providing, by the system, a message indicating that the test result data for the mapping was already generated.

8. The system of claim 7, wherein the upstream system is a policy admin system configured to perform the one or more first operations related to products.

9. The system of claim 8, wherein the downstream system includes one or more of a financial system, a claims system, or an operational and bureau reporting system.

10. The system of claim 7, wherein the underwriting workflow includes capturing policy data to underwrite a risk associated with the product based on one or more underwriting guidelines.

11. The system of claim 10, wherein capturing policy data includes capturing data related to account information, forms of the product, risk characteristic, coverages, premium and surcharges information, and billing information.

12. The system of claim 7, wherein the operation workflow includes executing a policy of the product during a life-cycle of the policy.

13. One or more non-transitory computer-readable storage media storing instructions that, when executed by the one or more computers, cause the one or more computers to perform operations comprising:
receiving an input that specifies a plurality of requirements for a product, wherein the plurality of requirements include (i) a first set of requirements defined for an upstream system that receives input for the product and performs one or more first operations on the input and specifying underwriting workflow and operational workflow associated with the product, and (ii) a second set of requirements defined for a downstream system that receives data generated by the upstream system and performs one or more second, different operations on the data and specifying attributes of the product the downstream system requires to create the product;
in response to receiving the input that specifies the plurality of requirements for the product, generating, using the input, meta-data that defines one or more values processed by the upstream system for the;
using the generated meta-data and the second set of requirements, automatically generating a data structure specifying a mapping between requirements from the first set of requirements defined for the upstream system to corresponding requirements from the second set of requirements defined for the downstream system;
in response to generating the data structure specifying the data mapping, generating, by the one or more computers, computer test data and one or more computer automated test scenarios and computer test data, the automated test scenarios defining a plurality of operations at least some of which require the computer test data as input for validating an accuracy of the upstream system and the downstream system given the first set of requirements and the second set of requirements using the computer test data including one or more data types, one or more default values, one or more minimum values, and one or more maximum values, the first set of requirements, the second set of requirements and the data mapping;
generating, by the one or more computers, test result data by executing, using at least a portion of the computer test data as input, the one or more computer automated test scenarios for validating the accuracy of the upstream system and the downstream system given the first set of requirements and the second set of requirements using the first set of requirements, the second set of requirements and the data mapping, wherein the one or more automated test scenarios, the computer test data, and the test result data comprise different data;
in response to validating the accuracy of the upstream system and the downstream system, storing, by the one or more computers and in one or more hardware storage devices, a) the data structure specifying the mapping between the first set of requirements defined for the upstream system and the second set of requirements defined for the downstream system and b) the test result data that indicates that the data structure is valid and the data processing system should not validate the accuracy of one or more requirements in the request given the test result data stored in the database;
receiving, by the one or more computers, a request that identifies the product;
determining, by the one or more computers and using second data from the one or more hardware storage devices, whether the one or more hardware storage devices include a previously generated data structure that specifies a previously generated mapping for the upstream and downstream systems for the product and whether the one or more computers should validate an accuracy of one or more requirements in the request; and
in response to determining that the hardware storage device includes the previously generated data structure that specifies the previously generated mapping for the upstream and downstream systems for the product and that the one or more computers should not validate the accuracy of one or more requirements in the request given the test result data stored in the database:
determining, by the one or more computers, to skip generation of another data structure specifying the mapping between the first set of requirements defined for the upstream system and the second set of requirements defined for the downstream system;
providing, by the one or more computers, the previously generated data structure specifying the mapping between the first set of requirements defined for the upstream system and the second set of requirements defined for the downstream system; and
providing, by the one or more computers, a message indicating that the test result data for the mapping was already generated.

14. The method of claim 1, wherein:
the first set of requirements comprises a first requirement and another, different first requirement;
the second set of requirements comprises a second requirement;
a third set of requirements defined for a second downstream system comprises a third requirement; and
generating the data structure comprises generating the data structure specifies the mapping between the first requirement to the second requirement and between the other, different first requirement and the third requirement.

15. The method of claim 1, wherein the computer test data comprises randomly computer generated values that satisfy the first and the second set of requirements, and the one or more computer automated test scenarios comprise a series of steps for validating the product.
